(19) United States
(12) Patent Application Publication
(10) Pub. No.: US 2023/0098333 A1
(43) Pub. Date: Mar. 30, 2023

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Yuki SHIMIZU, Kanagawa (JP)

(73) Assignee: FUJIFILM Business Innovation Corp., Tokyo (JP)

(21) Appl. No.: 17/705,371

(22) Filed: Mar. 27, 2022

(30) Foreign Application Priority Data
Sep. 24, 2021 (JP) 2021-156130

(51) Int. Cl. G10L 21/0364; G10L 25/60; G10L 21/034

(52) U.S. Cl. CPC G10L 21/0364; G10L 25/60; G10L 21/034; H04L 65/403

(57) ABSTRACT

An information processing apparatus includes: a processor configured to instantaneously acquire quality information indicative of quality of utterer's voice on a listener's side; and instantaneously present improvement information for improving the quality to the utterer in a case where the quality indicated by the acquired quality information does not satisfy a predetermined condition.

### CROSS-REFERENCE TO RELATED APPLICATIONS

This application is based on and claims priority under 35 USC 119 from Japanese Patent Application No. 2021-156130 filed Sep. 24, 2021.

### BACKGROUND

### (i) Technical Field

The present disclosure relates to an information processing apparatus, a non-transitory computer readable medium, and an information processing method.

### (ii) Related Art

Japanese Unexamined Patent Application Publication No. 08-125761 discloses a voice receiving apparatus that makes it possible to hold a conference having features unique to an audio conference that are not achieved by an actual conference.

This voice receiving apparatus includes a controller that generates a control signal for controlling, for each participant of an audio conference, acoustic quality, an acoustic property, or both of acoustic quality and an acoustic property obtained from a received audio signal. Furthermore, this voice receiving apparatus includes a converter that converts acoustic quality, an acoustic property, or both of acoustic quality and an acoustic property obtained from a received audio signal for each participant based on the control signal.

Japanese Unexamined Patent Application Publication No. 2012-094945 discloses an audio communication apparatus that allows a user to aurally understand how his or her voice is received in a listener's sound receiving environment without causing a transmission delay.

This audio communication apparatus includes an audio signal input unit to which an audio signal is input, an audio signal output unit that outputs an audio signal, and an audio signal receiving unit that receives an audio signal to be output to the audio output unit from another audio communication apparatus. Furthermore, this audio communication apparatus includes a measuring unit that measures environmental acoustic characteristics in a predetermined space and characteristic information transmitting unit that transmits information on the environmental acoustic characteristics measured by the measuring unit to the other audio communication apparatus.

### SUMMARY

Aspects of non-limiting embodiments of the present disclosure relate to an information processing apparatus, a non-transitory computer readable medium, and an information processing method that can improve utterer's voice more appropriately as compared with a case where quality of utterer's voice on a listener's side is not considered.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: instantaneously acquire quality information indicative of quality of utterer's voice on a listener's side; and instantaneously present improvement information for improving the quality to the utterer in a case where the quality indicated by the acquired quality information does not satisfy a predetermined condition.

### BRIEF DESCRIPTION OF THE DRAWINGS

An exemplary embodiment of the present disclosure will be described in detail based on the following figures, wherein:

FIG. 1 is a block diagram illustrating an example of a hardware configuration of an information processing system according to an exemplary embodiment;

FIG. 2 is a block diagram illustrating an example of a functional configuration of the information processing system according to the exemplary embodiment;

FIG. 3 is a schematic view illustrating an example of a configuration of a combination notification information database according to the exemplary embodiment;

FIG. 4 is a front view illustrating an example of a network meeting display screen according to the exemplary embodiment;

FIG. 5 is a front view illustrating another example of the network meeting display screen according to the exemplary embodiment;

FIG. 6 is a flowchart illustrating an example of information processing according to the exemplary embodiment;

FIG. 7 is a flowchart illustrating an example of sound volume adjusting processing according to the exemplary embodiment; and

FIG. 8 is a flowchart illustrating an example of combination evaluation processing according to the exemplary embodiment.

### DETAILED DESCRIPTION

An exemplary embodiment of the present disclosure is described in detail below with reference to the drawings. The present exemplary embodiment describes a case where the present disclosure is applied to an information processing system including plural terminal apparatuses used individually by participants of a meeting held over a network (hereinafter referred to as a “network meeting”) and an information processing apparatus that collectively manages the network meeting. The “meeting” as used herein refers to not only a conference held, for example, in a company or between companies, but also every kinds of events involving conversation among plural persons such as a training workshop, a lecture meeting, a convivial gathering not involving alcohol drinking, and a convivial gathering (drinking party) involving alcohol drinking.

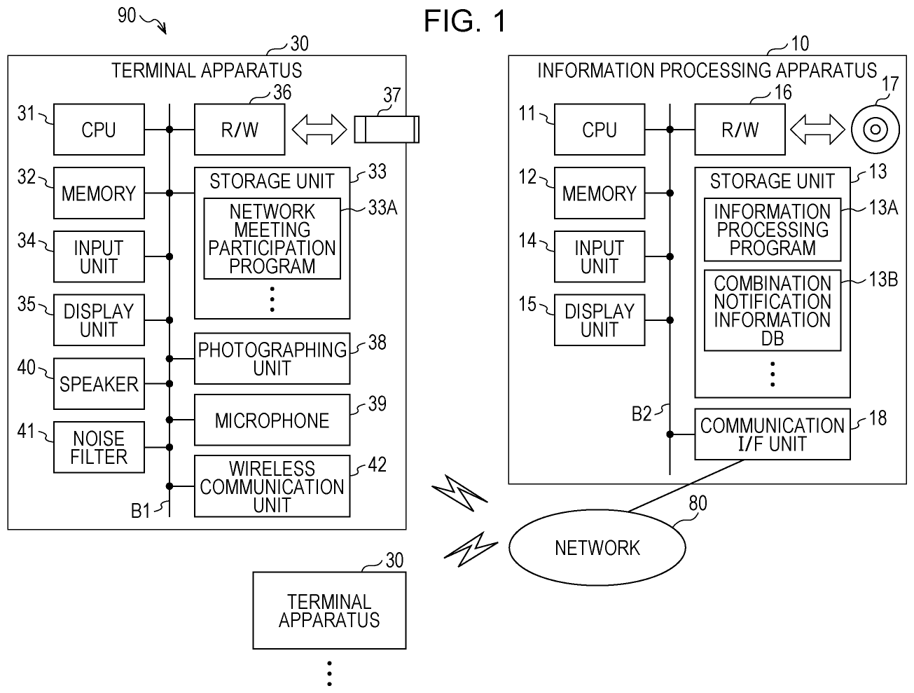

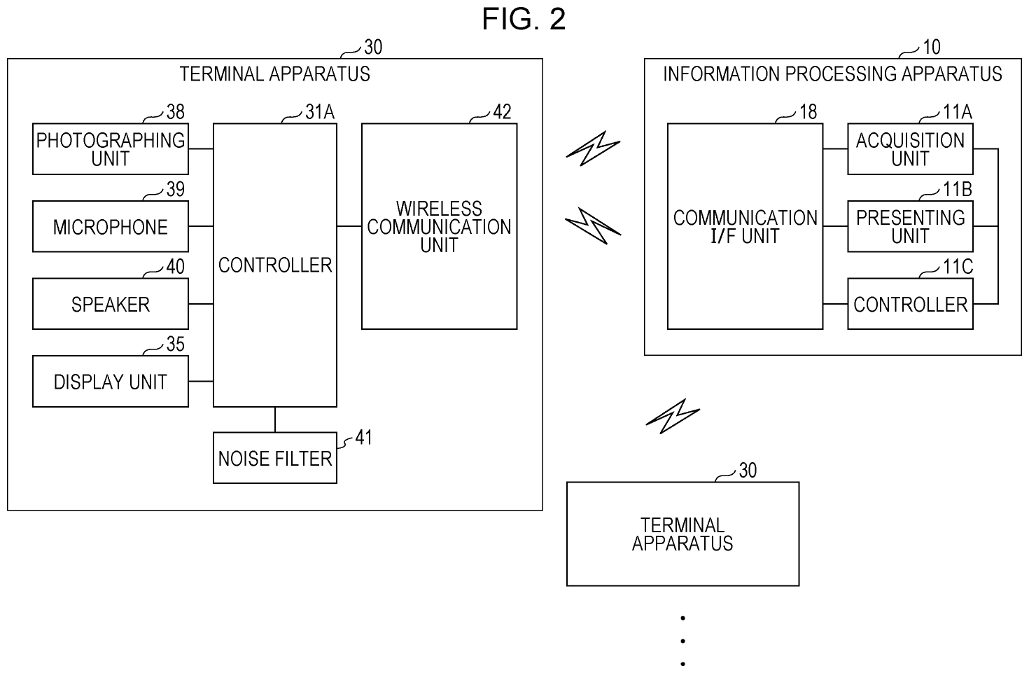

First, a configuration of an information processing system 90 according to the present exemplary embodiment is described with reference to FIGS. 1 and 2. FIG. 1 is a block diagram illustrating an example of a hardware configuration of the information processing system 90 according to the present exemplary embodiment. FIG. 2 is a block diagram illustrating an example of a functional configuration of the information processing system 90 according to the present exemplary embodiment.

As illustrated in FIG. 1, the information processing system 90 according to the present exemplary embodiment includes an information processing apparatus 10 and plural terminal apparatuses 30, each of which can access a network 80. Note that examples of the information processing apparatus 10 include various computers such as a personal computer and a server computer. Examples of the terminal apparatuses 30 include not only various computers, but also mobile devices such as a smartphone, a tablet PC, and a personal digital assistant (PDA), and a mobile information terminal. In the present exemplary embodiment, a case where mobile devices are applied as the terminal apparatuses 30 is described.

The terminal apparatuses 30 according to the present exemplary embodiment are terminals which participants in a network meeting managed by the information processing system 90 (hereinafter simply referred to as “participants”) own. Each of the terminal apparatuses 30 includes a central processing unit (CPU) 31, a memory 32 as a temporary storage region, a non-volatile storage unit 33, an input unit 34 such as a touch panel, a display unit 35 such as a liquid crystal display, and a medium read/write device (R/W) 36. Furthermore, each of the terminal apparatuses 30 includes a photographing unit 38, a microphone 39, a speaker 40, a noise filter 41, and a wireless communication unit 42. The CPU 31, the memory 32, the storage unit 33, the input unit 34, the display unit 35, the medium read/write device 36, the photographing unit 38, the microphone 39, the speaker 40, the noise filter 41, and the wireless communication unit 42 are connected to one another through a bus B1. The medium read/write device 36 reads out information written into a recording medium 37 and writes information into the recording medium 37.

The storage unit 33 is a hard disk drive (HDD), a solid state drive (SSD), a flash memory, or the like. The storage unit 33 as a storage medium stores therein a network meeting participation program 33A. The recording medium 37 into which the network meeting participation program 33A has been written is set in the medium read/write device 36, and the medium read/write device 36 reads out the network meeting participation program 33A from the recording medium 37, and thereby the network meeting participation program 33A is stored (installed) into the storage unit 33. The CPU 31 reads out the network meeting participation program 33A from the storage unit 33, loads the network meeting participation program 33A to the memory 32, and sequentially executes processes of the network meeting participation program 33A.

The photographing unit 38 according to the present exemplary embodiment photographs a moving image for a participant and outputs image information thus obtained. The microphone 39 according to the present exemplary embodiment collects voice uttered by a participant and outputs audio information. The speaker 40 according to the present exemplary embodiment reproduces voice indicated by audio information.

Furthermore, the noise filter 41 according to the present exemplary embodiment has a function of removing noise in voice collected by the microphone 39 and a function of removing noise in voice reproduced by the speaker 40.

Although a bandpass filter that allows only a signal in a frequency band of human voice to pass therethrough is used as the noise filter 41 in the present exemplary embodiment, this is not restrictive. For example, a low-pass filter or a high-pass filter that allows a signal including a frequency band of human voice to pass therethrough may be applied as the noise filter 41 or a noise removal filter that removes only a specific noise component may be applied as the noise filter 41. Although the noise filter 41 configured as hardware is applied to remove noise in voice in the present exemplary embodiment, this is not restrictive. For example, a noise filter configured as software may be applied or a noise filter configured as a combination of software and hardware may be applied.

Meanwhile, the information processing apparatus 10 is an apparatus that plays a central role in the information processing system 90 and collectively manages a network meeting managed by the information processing system 90 (hereinafter simply referred to as a “network meeting”), as described above. The information processing apparatus 10 includes a CPU 11, a memory 12 as a temporary storage region, a non-volatile storage unit 13, an input unit 14 such as a keyboard and a mouse, a display unit 15 such as a liquid crystal display, a medium read/write device 16, and a communication interface (I/F) unit 18. The CPU 11, the memory 12, the storage unit 13, the input unit 14, the display unit 15, the medium read/write device 16, and the communication I/F unit 18 are connected to one another through a bus B2. The medium read/write device 16 reads out information written into a recording medium 17 and writes information into the recording medium 17.

The storage unit 13 is an HDD, an SSD, a flash memory, or the like. The storage unit 13 as a storage medium stores therein various programs such as an information processing program 13A.

A recording medium 17 in which various programs such as the information processing program 13A have been written is set in the medium read/write device 16, and the medium read/write device 16 reads out the various programs from the recording medium 17, and thereby the various programs are stored (installed) into the storage unit 13. The CPU 11 reads out the various programs from the storage unit 13, loads the various programs to the memory 12, and sequentially executes processes of the various programs.

Furthermore, the storage unit 13 stores therein a combination notification information database 13B. Details of the combination notification information database 13B will be described later.

Although a public communication line such as the Internet or a telephone network is applied as the network 80 in the present exemplary embodiment, this is not restrictive. For example, an in-company communication line such as a local area network (LAN) or a wide area network (WAN) may be applied as the network 80 or a combination of an in-company communication line and a public communication line may be applied as the network 80.

Next, functional configurations of the information processing apparatus 10 and the terminal apparatuses 30 according to the present exemplary embodiment are described with reference to FIG. 2.

As illustrated in FIG. 2, each of the terminal apparatuses 30 according to the present exemplary embodiment includes a controller 31A. The CPU 31 of each of the terminal apparatuses 30 executes the network meeting participation program 33A and thus functions as the controller 31A.

The controller 31A according to the present exemplary embodiment controls photographing of a participant by the photographing unit 38 and collection of voice uttered by a participant by the microphone 39. Furthermore, the controller 31A according to the present exemplary embodiment controls reproduction of sound by the speaker 40, display of various kinds of information by the display unit 35, and communication with the information processing apparatus 10 by the wireless communication unit 42. Furthermore, the controller 31A according to the present exemplary embodiment controls removal of noise from voice by the noise filter 41. In addition, the controller 31A according to the present exemplary embodiment performs various kinds of control for holding a network meeting.

Meanwhile, as illustrated in FIG. 2, the information processing apparatus 10 according to the present exemplary embodiment includes an acquisition unit 11A, a presenting unit 11B, and a controller 11C. The CPU 11 of the information processing apparatus 10 executes the information processing program 13A and thus functions as the acquisition unit 11A, the presenting unit 11B, and the controller 11C.

The acquisition unit 11A according to the present exemplary embodiment instantaneously acquires quality information (hereinafter simply referred to as “quality information”) indicative of quality of utterer's voice on a listener's side during a network meeting.

The acquisition unit 11A according to the present exemplary embodiment acquires quality information from a result of a listener's evaluation. In particular, the acquisition unit 11A according to the present exemplary embodiment acquires quality information from results of evaluations made by plural listeners.

Although the acquisition unit 11A acquires quality information from a result of an evaluation made by a listener in the present exemplary embodiment, this is not restrictive. For example, quality information may be automatically acquired by determining quality of voice indicated by audio information obtained by the microphone 39 of the terminal apparatus 30 used by an utterer. Alternatively, quality information may be automatically acquired by determining quality of voice indicated by audio information indicative of voice uttered by an utterer reproduced by the speaker 40 of the terminal apparatus 30 used by a listener.

The presenting unit 11B according to the present exemplary embodiment instantaneously presents improvement information for improving the quality in a case where the quality indicated by the quality information acquired by the acquisition unit 11A does not satisfy a predetermined condition. Although the improvement information is presented by using a display screen in the present exemplary embodiment, this is not restrictive. For example, the improvement information may be presented by voice using the speaker 40.

The presenting unit 11B according to the present exemplary embodiment decides contents of presented improvement information in accordance with plural evaluation results. Although the evaluation is made by using a display screen during utterance of an utterer in the present exemplary embodiment, this is not restrictive. For example, the evaluation may be made by input of voice using the microphone 39.

Meanwhile, the controller 11C according to the present exemplary embodiment performs control for improving the quality in a case where the quality does not satisfy the predetermined condition.

Although the controller 11C according to the present exemplary embodiment performs the control for improving the quality on both of the terminal apparatus 30 used by the utterer and the terminal apparatus 30 used by the listener, this is not restrictive. For example, the control for improving the quality may be performed on either the terminal apparatus 30 used by the utterer or the terminal apparatus 30 used by the listener.

In a case where there are plural listeners and the quality does not satisfy the condition for a predetermined number of listeners or more among the plural listeners, the controller 11C according to the present exemplary embodiment performs the control on the terminal apparatus 30 used by the utterer.

Meanwhile, in a case where there are plural listeners and the quality does not satisfy the condition for less than the predetermined number of listeners among the plural listeners, the controller 11C according to the present exemplary embodiment performs the control on the terminal apparatus(es) 30 used by the listener(s).

Furthermore, although the quality of voice is quality concerning both of a voice volume and voice clarity in the present exemplary embodiment, this is not restrictive. For example, quality concerning either a voice volume and voice clarity may be applied as the quality of voice. Although the presence or absence of noise, the presence or absence of interruption of voice, and the presence or absence of muffling of voice are applied as targets of the clarity of voice, this is not restrictive. For example, an amount of noise, frequency of interruption of voice, and a degree of muffling of voice may be applied as targets of the clarity of voice. In either case, three kinds, specifically, noise, interruption of voice, and muffling of voice are not necessarily applied, and only any one of these three kinds or a combination of any two of these three kinds may be applied.

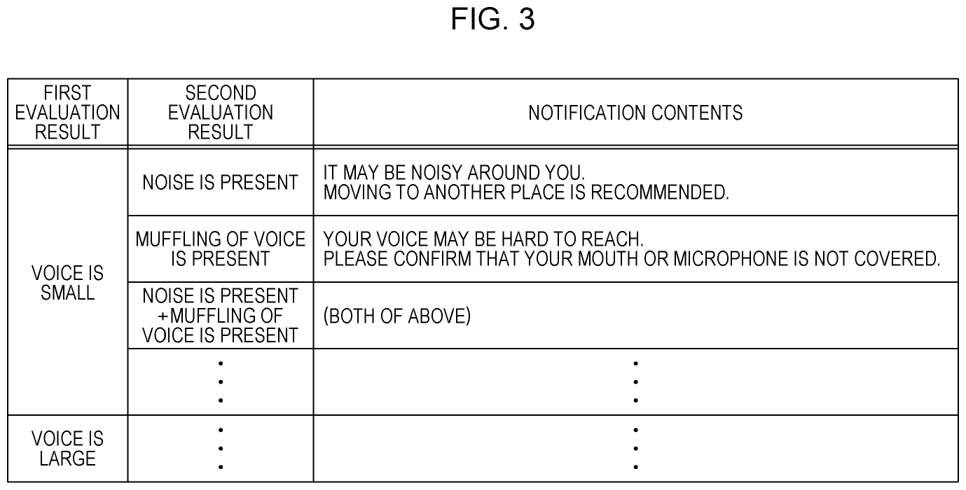

Next, the combination notification information database 13B according to the present exemplary embodiment is described with reference to FIG. 3. FIG. 3 is a schematic view illustrating an example of a configuration of the combination notification information database 13B according to the present exemplary embodiment.

The combination notification information database 13B according to the present exemplary embodiment is a database in which information to be presented to an utterer in accordance with a combination of a result of evaluation of a voice volume and a result of evaluation of voice clarity is registered. As illustrated in FIG. 3, the combination notification information database 13B according to the present exemplary embodiment stores therein a first evaluation result, a second evaluation result, and notification contents in association with one another.

The first evaluation result is information indicative of a result of evaluation of the voice volume, and the second evaluation result is information indicative of a result of evaluation of the voice clarity. The notification information is information indicative of contents to be presented to an utterer in accordance with corresponding first evaluation result and second evaluation result.

In the example illustrated in FIG. 3, for example, “IT MAY BE NOISY AROUND YOU. MOVING TO ANOTHER PLACE IS RECOMMENDED.” is registered as contents to be presented in a case where the result of evaluation of the voice volume is “VOICE IS SMALL” and the result of evaluation of the voice clarity is “NOISE IS PRESENT”.

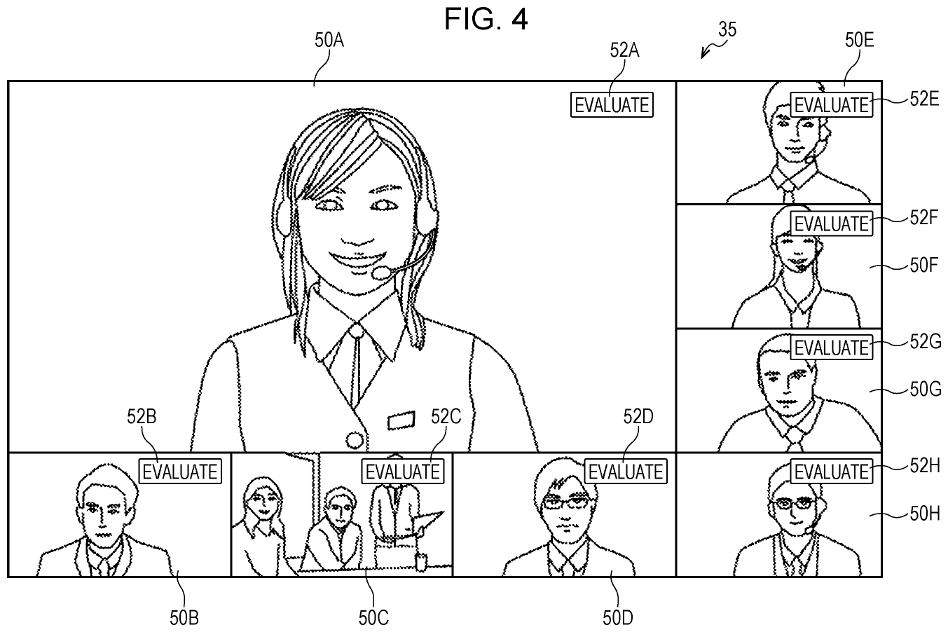

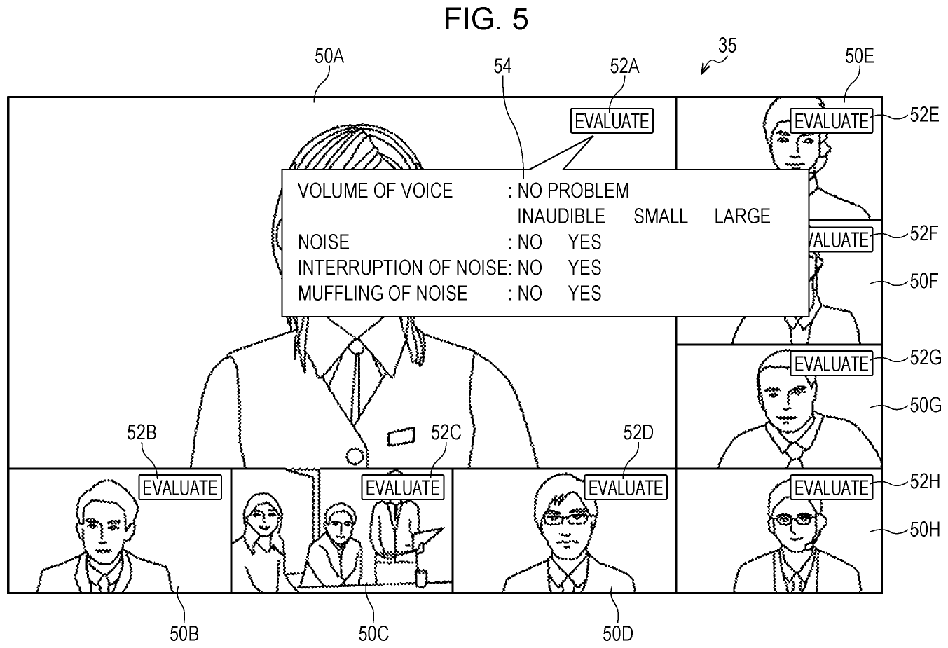

Next, a method for evaluating voice for an utterer during participation in a network meeting in the information processing system 90 according to the present exemplary embodiment is described with reference to FIGS. 4 and 5. FIG. 4 is a front view illustrating an example of a network meeting display screen according to the present exemplary embodiment. FIG. 5 is a front view illustrating another example of the network meeting display screen according to the present exemplary embodiment.

In the information processing system 90 according to the present exemplary embodiment, in a case where a network meeting is held, the network meeting participation program 33A is executed by the CPU 31 in the terminal apparatus 30 of each participant in the network meeting. When the network meeting participation program 33A is executed, a network meeting display screen illustrated, for example, in FIG. 4 is displayed on the display unit 35 of the terminal apparatus 30 of each participant.

As illustrated in FIG. 4, photographed images 50A to 50H of the participants photographed by the photographing units 38 of the terminal apparatuses 30 are displayed in real time on the network meeting display screen according to the present exemplary embodiment. Furthermore, on the network meeting display screen, evaluation buttons 52A to 52H, which are selected to make an evaluation concerning voice, are displayed within display regions of the photographed images for the participants displayed in the display regions.

In a case where a participant (listener) in the network meeting makes an evaluation concerning quality of voice uttered by another participant (utterer), the participant (listener) selects an evaluation button in a region where the utterer is displayed by using the input unit 34.

In response to this selection, a selection screen 54 on which four kinds of items “VOLUME OF VOICE”, “NOISE”, “INTERRUPTION OF VOICE”, and “MUFFLING OF VOICE” are displayed together with options of evaluation is displayed for the selected evaluation button on the network meeting display screen, for example, as illustrated in FIG. 5. For example, four kinds of options “NO PROBLEM”, “INAUDIBLE”, “SMALL”, and “LARGE” are displayed as options of evaluation concerning the “VOLUME OF VOICE”. For example, two kinds of options “NO” and “YES” are displayed as options of evaluation concerning the “NOISE”. Note, however, that this is not restrictive. For example, only options of evaluation that are to be selected in a case where there is a problem may be displayed by deleting “NO PROBLEM” and “NO” in FIG. 5.

The listener selects an option corresponding to a result of his or her evaluation among the displayed items by using the input unit 34. In response to the selection of the option, information indicative of the selected option is transmitted from the terminal apparatus 30 used by the listener to the information processing apparatus 10 through the wireless communication unit 42.

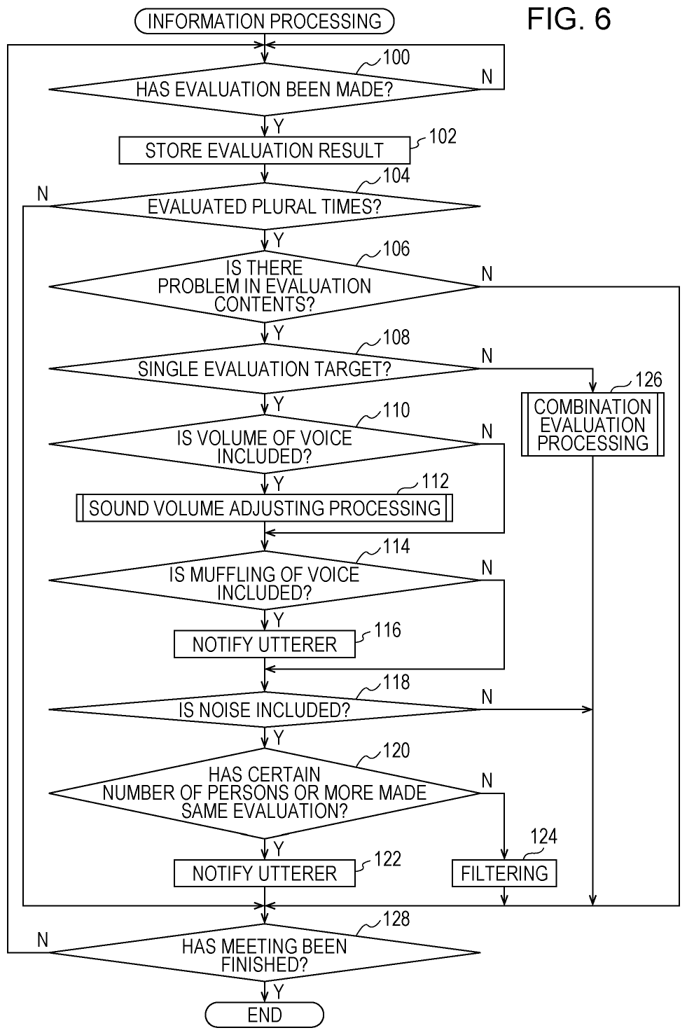

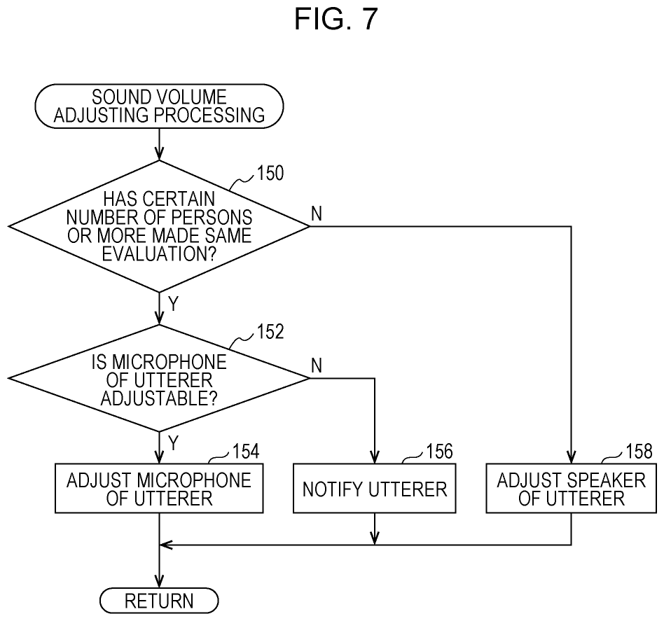

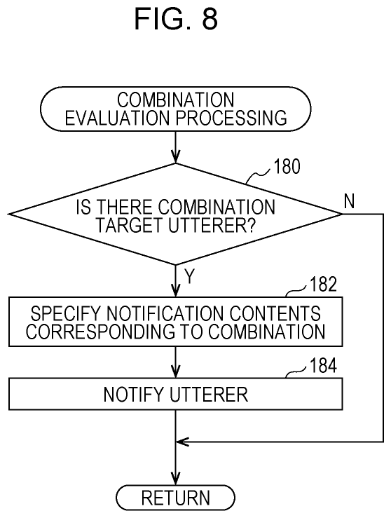

Next, operation of the information processing apparatus 10 is described as operation of the information processing system 90 according to the present exemplary embodiment with reference to FIGS. 6 to 8. FIG. 6 is a flowchart illustrating an example of information processing according to the present exemplary embodiment. FIG. 7 is a flowchart illustrating an example of sound volume adjusting processing according to the present exemplary embodiment. FIG. 8 is a flowchart illustrating an example of combination evaluation processing according to the present exemplary embodiment. Note that only processing concerning evaluation of voice during a network meeting is described, and description of processing concerning the network meeting itself is omitted in order to avoid confusion. Furthermore, a case where two kinds “NOISE”, and “MUFFLING OF VOICE” are applied as evaluation items concerning voice clarity is described in order to avoid confusion. Furthermore, a case where the combination notification information database 13B has been already constructed is described in order to avoid confusion.

In the information processing apparatus 10 according to the present exemplary embodiment, the CPU 11 executes the information processing program 13A at a timing at which any (hereinafter referred to as a “target meeting”) of network meetings managed in the information processing system 90 starts, and thereby information processing illustrated in FIG. 6 is performed.

In step 100 of FIG. 6, the CPU 11 waits until any of the evaluation buttons 52 is selected on the network meeting display screen by any of participants participating in the target meeting and any of evaluation results is selected on the selection screen 54 displayed in response to the selection of the evaluation button 52.

In step 102, the CPU 11 causes information (hereinafter referred to as “evaluation result information”) indicative of the selected evaluation result to be stored in the storage unit 13. In step 104, the CPU 11 determines whether or not the evaluation result information has been obtained plural times during the target meeting. In a case where a result of the determination is negative, step 128 is performed, whereas in a case where the result of the determination is positive, step 106 is performed.

In step 106, the CPU 11 reads out evaluation result information stored in the storage unit 13 so far and determines whether or not there is a problem in an evaluation result (hereinafter referred to as a “target evaluation result”) within a predetermined period (30 seconds in the present exemplary embodiment) before this timing by using the evaluation result information. In a case where a result of the determination is negative, step 128 is performed, whereas in a case where the result of the determination is positive, step 108 is performed.

In the information processing according to the present exemplary embodiment, whether or not there is a problem in the target evaluation result is determined by determining whether or not one or more negative evaluation results are included in the target evaluation result. The negative evaluation result is an evaluation result other than “NO PROBLEM” as for the voice volume and is an evaluation result “YES” as for voice clarity.

Although whether or not there is a problem in the target evaluation result is determined by determining whether or not one or more negative evaluation results are included in the target evaluation result in the present exemplary embodiment, this is not restrictive. For example, whether or not there is a problem in the target evaluation result may be determined by determining whether or not plural negative evaluation results are included in the target evaluation result.

In step 108, the CPU 11 determines whether or not an evaluation target of the negative evaluation result in the target evaluation result is only any one of the voice volume and voice clarity. In a case where a result of the determination is positive, step 110 is performed.

In step 110, the CPU 11 determines whether or not the voice volume is included in the evaluation target of the negative evaluation result in the target evaluation result. In a case where a result of the determination is negative, step 114 is performed, whereas in a case where the result of the determination is positive, step 112 is performed.

In step 112, the CPU 11 executes sound volume adjusting processing illustrated, for example, in FIG. 7.

In step 150 of the sound volume adjusting processing, the CPU 11 determines whether or not the negative evaluation result concerning the voice volume in the target evaluation result has been made for an identical utterer by a predetermined number of listeners or more. In a case where a result of the determination is positive, step 152 is performed. Hereinafter, an utterer for which the result of the determination in this process is positive is referred to as a “sound volume adjustment target utterer”. Note that although a predetermined proportion (½ in the present exemplary embodiment) of the participants of the target meeting is applied as the predetermined number of listeners, this is not restrictive. For example, the number obtained by subtracting the utterer from the number of participants of the target meeting, that is, the number of all of the participants excluding the utterer may be applied as the predetermined number of listeners.

In step 152, the CPU 11 determines whether or not sensitivity of the microphone 39 (hereinafter referred to as a “target microphone”) of the terminal apparatus 30 used by the sound volume adjustment target utterer is adjustable. In a case where a result of the determination is positive, step 154 is performed. In the present exemplary embodiment, in a case where the negative evaluation result is an evaluation result “INAUDIBLE” or “SMALL”, it is determined that the sensitivity of the microphone 39 is not adjustable in a case where the sensitivity of the target microphone has been set to a maximum value of an adjustable range. Furthermore, in the present exemplary embodiment, in a case where the negative evaluation result is “LARGE”, it is determined that the sensitivity of the microphone 39 is not adjustable in a case where the sensitivity of the target microphone has been set to a minimum value of the adjustable range.

In step 154, the CPU 11 adjusts the sensitivity of the target microphone and then finishes the sound volume adjusting processing. In the present exemplary embodiment, in a case where the negative evaluation result is “INAUDIBLE” or “SMALL”, the sensitivity of the target microphone is increased by a predetermined degree so as not to exceed the maximum value. Furthermore, in the present exemplary embodiment, in a case where the negative evaluation result is “LARGE”, the sensitivity of the target microphone is decreased by a predetermined degree so as not to become lower than the minimum value. Note that although 1/10 of the adjustable range is applied as the predetermined degree in the present exemplary embodiment, it is needless to say that this is not restrictive.

Meanwhile, in a case where the result of the determination in step 152 is negative, step 156 is performed, in which the CPU 11 transmits predetermined notification information to the terminal apparatus 30 used by the sound volume adjustment target utterer and then finishes the sound volume adjusting processing. As a result of the transmission of the notification information, contents of the notification information are displayed on the display unit 35 of the terminal apparatus 30 of the sound volume adjustment target utterer. In the present exemplary embodiment, information giving an instruction to lower a volume of utterance is applied as the notification information in a case where the evaluation result is that the voice is large, and information giving an instruction to increase a volume of utterance is applied as the notification information in a case where the evaluation result is that the voice is small or inaudible.

Meanwhile, in a case where the result of the determination in step 150 is negative, it is regarded that the negative evaluation result in the target evaluation result was made for the identical utterer by less than the predetermined number of listeners (hereinafter referred to as a “sound volume adjustment target listener”), and step 158 is performed.

In step 158, the CPU 11 adjusts a reproduced sound volume of the speaker 40 (hereinafter referred to as a “target speaker”) of the terminal apparatus 30 used by the sound volume adjustment target listener and then finishes the sound volume adjusting processing. In the present exemplary embodiment, in a case where the negative evaluation result is “INAUDIBLE” or “SMALL”, the reproduced sound volume of the target speaker is increased by a predetermined amount so as not to exceed a maximum sound volume. Meanwhile, in the present exemplary embodiment, in a case where the negative evaluation result is “LARGE”, the reproduced sound volume of the target speaker is decreased by a predetermined amount so as not to become lower than a minimum sound volume. Although 1/10 of an adjustable range of the target speaker is applied as the predetermined amount in the present exemplary embodiment, this is not restrictive.

Furthermore, although adjustment of the reproduced sound volume is applied to all sounds output from the target speaker of the sound volume adjustment target listener in the present exemplary embodiment, this is not restrictive. Voice uttered by the utterer for whom a negative evaluation has been made by the sound volume adjustment target listener may be specified by the terminal apparatus 30 used by the sound volume adjustment target listener, and only a reproduced sound volume of voice uttered by the utterer for whom the negative evaluation has been made may be adjusted.

When the sound volume adjusting processing is finished, step 114 of the information processing illustrated in FIG. 6 is performed.

In step 114, the CPU 11 determines whether or not muffling of voice is included in the evaluation target of the negative evaluation result in the target evaluation result. In a case where a result of the determination is negative, step 118 is performed, whereas in a case where the result of the determination is positive, step 116 is performed. Hereinafter, an utterer for which the negative evaluation result has been made in this processing is referred to as a “voice muffling adjustment target utterer”.

In step 116, the CPU 11 transmits predetermined notification information to the terminal apparatus 30 used by the voice muffling adjustment target utterer, and then step 118 is performed. As a result of the transmission of the notification information, contents of the notification information are displayed on the display unit 35 of the terminal apparatus 30 of the voice muffling adjustment target utterer. In the present exemplary embodiment, information giving an instruction to more clearly speak since voice is muffled on a listener's side is applied as the notification information.

In step 118, the CPU 11 determines whether or not noise is included in the evaluation target of the negative evaluation result in the target evaluation result. In a case where a result of the determination is negative, step 128 is performed, whereas in a case where the result of the determination is positive, step 120 is performed.

In step 120, the CPU 11 determines whether or not the negative evaluation result concerning noise in the target evaluation result has been made for the identical utterer by the predetermined number of listeners or more. In a case where a result of the determination is positive, step 122 is performed. Hereinafter, an utterer for whom the negative evaluation result has been made in this processing is referred to as a “noise adjustment target utterer”.

In step 122, the CPU 11 transmits predetermined notification information to the terminal apparatus 30 used by the noise adjustment target utterer, and then step 128 is performed. As a result of the transmission of the notification information, contents of the notification information are displayed on the display unit 35 of the terminal apparatus 30 of the noise adjustment target utterer. In the present exemplary embodiment, information giving an instruction to remove a cause of noise or speak more loudly since noise is included in voice on a listener's side is applied as the notification information.

Meanwhile, in a case where a result of the determination in step 120 is negative, it is regarded that the negative evaluation result concerning noise has been made for the identical utterer by less than the predetermined number of listeners (hereinafter referred to as a “noise adjustment target listener”), and step 124 is performed.

In step 124, the CPU 11 controls the terminal apparatus 30 used by the noise adjustment target listener to cut noise in voice reproduced by the speaker 40 by using the noise filter 41, and then step 128 is performed.

Meanwhile, in a case where a result of the determination in step 108 is negative, it is regarded that both of volume of voice and clarity of voice are evaluation targets of the negative evaluation result in the target evaluation result, and step 126 is performed, in which the CPU 11 executes combination evaluation processing illustrated, for example, in FIG. 8.

In step 180 of the combination evaluation processing, the CPU 11 determines whether or not there is an utterer (hereinafter referred to as a “combination target utterer”) who is a target of a combination of negative evaluation results of both of volume of voice and clarity of voice. In a case where a result of the determination is negative, the combination evaluation processing is finished, whereas in a case where the result of the determination is positive, step 182 is performed.

In step 182, the CPU 11 reads out notification contents corresponding to the combination of the negative evaluation results of both of volume of voice and clarity of voice in the target evaluation result from the combination notification information database 13B. In step 184, the CPU 11 transmits information indicative of the notification contents thus read out to the terminal apparatus 30 used by the combination target utterer and then finishes the combination evaluation processing. As a result of the transmission of the information indicative of the notification contents, the notification contents are displayed on the terminal apparatus 30 used by the combination target utterer. For example, in a case where the combination notification information database 13B is one illustrated in FIG. 3, and the evaluation result concerning the volume of voice is “VOICE IS SMALL” and the evaluation result concerning clarity of voice is “NOISE IS PRESENT”, “IT MAY BE NOISY AROUND YOU. MOVING TO ANOTHER PLACE IS RECOMMENDED.” is displayed on the display unit 35 of the terminal apparatus 30 used by the combination target utterer.

When the combination evaluation processing is finished, step 128 of the information processing illustrated in FIG. 6 is performed.

In step 128, the CPU 11 determines whether or not the target meeting has been finished. In a case where a result of the determination is negative, step 100 is performed again, whereas in a case where the result of the determination is positive, the information processing is finished. Note that although whether or not the target meeting has been finished is determined by determining whether or not time and date of end of the target meeting has arrived in the present exemplary embodiment, this is not restrictive. For example, whether or not the target meeting has been finished may be determined by determining whether or not all of the network meeting participation programs 33A executed in the terminal apparatuses 30 of the participants in the target meeting have been terminated.

Although a case where the items concerning clarity of voice in the information processing are “NOISE” and “MUFFLING OF VOICE” has been described in the above exemplary embodiment, this is not restrictive. For example, “INTERRUPTION OF VOICE” may be included as an item of clarity of voice in the information processing. Furthermore, any one of “NOISE”, “MUFFLING OF VOICE”, and “INTERRUPTION OF VOICE” or a combination of any two of these may be applied as an item of clarity of voice in the information processing.

Furthermore, the combination notification information database 13B applied in the above exemplary embodiment is not limited to the one illustrated in FIG. 3. Needless to say, other notification contents may be used as long as the notification contents can be applied to address a voice quality problem that is occurring.

Furthermore, in a case where the evaluation does not change even after the microphone 39 or the like is adjusted or noise is removed by the noise filter 41 to address the voice quality problem, a similar notification to that in the above exemplary embodiment may be given to the utterer although this is not mentioned in the above exemplary embodiment. In this case, for example, in a case where the evaluation concerning noise does not change, a kind of noise may be specified, and a notification including a cause (e.g., noise caused by surrounding devices, utterances of surrounding persons) corresponding to the kind of noise thus specified may be given to the utterer.

Although the exemplary embodiment has been described above, the technical scope of the present disclosure is not limited to the scope described in the above exemplary embodiment. The above exemplary embodiment may be changed or modified in various ways without departing from the spirit of the present disclosure, and the changes or modifications are also encompassed within the technical scope of the present disclosure.

The above exemplary embodiment does not limit the disclosure in the claims, and not all features described in the exemplary embodiment are necessarily needed for solution of the problem to be solved by the disclosure. The above exemplary embodiment includes disclosures in various stages, and various disclosures are extracted by combinations of disclosed plural constituent elements. Even if some constituent elements are deleted from all constituent elements described in the exemplary embodiment, this configuration in which these constituent elements have been deleted can be extracted as a disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

Furthermore, although a case where the information processing is realized by a software configuration by using a computer by executing a program has been described in the above exemplary embodiment, the present disclosure is not limited to this. For example, the information processing may be realized by a hardware configuration or may be realized by a combination of a hardware configuration and a software configuration.

In addition, the configuration of the information processing apparatus 10 described in the above exemplary embodiment is an example, and it is needless to say that an unnecessary part may be deleted or a new part may be added without departing from the spirit of the present disclosure.

Furthermore, the flow of the information processing described in the above exemplary embodiment is an example, and it is needless to say that an unnecessary step may be deleted, a new step may be added, or a processing order may be changed without departing from the spirit of the present disclosure.

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
instantaneously acquire quality information indicative of quality of utterer's voice on a listener's side; and
instantaneously present improvement information for improving the quality to the utterer in a case where the quality indicated by the acquired quality information does not satisfy a predetermined condition.

2. The information processing apparatus according to claim 1, wherein:
the processor is configured to acquire the quality information from a result of an evaluation made by the listener.

3. The information processing apparatus according to claim 2, wherein:
the listener is one of a plurality of listeners, and the processor is configured to acquire the quality information from results of evaluations made by the plurality of listeners.

4. The information processing apparatus according to claim 3, wherein:
the processor is configured to decide contents of the presented improvement information in accordance with the plurality of results of the evaluations.

5. The information processing apparatus according to claim 2, wherein:
the evaluation is made by using a display screen during utterance of the utterer.

6. The information processing apparatus according to claim 3, wherein:
the evaluation is made by using a display screen during utterance of the utterer.

7. The information processing apparatus according to claim 4, wherein:
the evaluation is made by using a display screen during utterance of the utterer.

8. The information processing apparatus according to claim 1, wherein:
the processor is configured to further perform control for improving the quality in a case where the quality does not satisfy the predetermined condition.

9. The information processing apparatus according to claim 2, wherein:
the processor is configured to further perform control for improving the quality in a case where the quality does not satisfy the predetermined condition.

10. The information processing apparatus according to claim 3, wherein:
the processor is configured to further perform control for improving the quality in a case where the quality does not satisfy the predetermined condition.

11. The information processing apparatus according to claim 4, wherein:
the processor is configured to further perform control for improving the quality in a case where the quality does not satisfy the predetermined condition.

12. The information processing apparatus according to claim 5, wherein:
the processor is configured to further perform control for improving the quality in a case where the quality does not satisfy the predetermined condition.

13. The information processing apparatus according to claim 6, wherein:
the processor is configured to further perform control for improving the quality in a case where the quality does not satisfy the predetermined condition.

14. The information processing apparatus according to claim 7, wherein:
the processor is configured to further perform control for improving the quality in a case where the quality does not satisfy the predetermined condition.

15. The information processing apparatus according to claim 8, wherein:
the processor is configured to perform the control for improving the quality on at least one of a terminal apparatus used by the utterer and a terminal apparatus used by the listener.

16. The information processing apparatus according to claim 15, wherein:
the listener is one of a plurality of listeners, and the processor is configured to perform the control on the terminal apparatus used by the utterer in a case where there are the plurality of listeners and the quality does not satisfy the condition for a predetermined number of listeners or more among the plurality of listeners.

17. The information processing apparatus according to claim 15, wherein:
the listener is one of a plurality of listeners, and the processor is configured to perform the control on the terminal apparatus used by the listener in a case where there are the plurality of listeners and the quality does not satisfy the condition for less than a predetermined number of listeners among the plurality of listeners.

18. The information processing apparatus according to claim 1, wherein:
the quality of the voice is quality of at least one of a volume of the voice and clarity of the voice.

19. A non-transitory computer readable medium storing a program causing a computer to execute a process for information processing, the process comprising:
instantaneously acquiring quality information indicative of quality of utterer's voice on a listener's side; and
instantaneously presenting improvement information for improving the quality to the utterer in a case where the quality indicated by the acquired quality information does not satisfy a predetermined condition.

20. An information processing method comprising:
instantaneously acquiring quality information indicative of quality of utterer's voice on a listener's side; and
instantaneously presenting improvement information for improving the quality to the utterer in a case where the quality indicated by the acquired quality information does not satisfy a predetermined condition.
